(19) United States
(12) Patent Application Publication
(10) Pub. No.: US 2008/0309033 A1
(43) Pub. Date: Dec. 18, 2008

(54) ROOFING CART

(76) Inventors: Jeffery W. Twardzik, Calumet, MI (US); Mark L. Bonenfant, Laurium, MI (US)

Correspondence Address: PRICE HENEVELD COOPER DEWITT & LITTON, LLP, 695 KENMOOR, S.E., P O BOX 2567, GRAND RAPIDS, MI, 49501, US

(21) Appl. No.: 11/764,258

(22) Filed: Jun. 18, 2007

(51) Int. Cl. B62M 1/18

(52) U.S. Cl. 280/32.5; 280/200

(57) ABSTRACT

A ridge roofing cart can be made using mounting brackets for receiving an elongated support platform. Each bracket includes spaced plates for receiving an axle between the plates on each side thereof and an aperture for receiving an axle pivot pin at one position on the bracket. Each bracket has a plurality of apertures spaced from the pivot aperture for setting the angular position of the axle on each side of the bracket in relationship to the support platform corresponding to standard roof pitch angles. The brackets can be mounted at opposite ends of a support platform to define a cart in which the axles rotatable hold wheels which span the ridge of a roof.

### BACKGROUND OF THE INVENTION

The present invention relates to a cart having adjustable angled axles for spanning the apex of roofs of different pitches to facilitate the installation of roof ridge shingles or coverings.

When the shingles or other protective covering for a roof have been applied from the lower edge of the roof to the peak or ridge, the ridge itself is then shingled or otherwise covered to seal the roof from environmental conditions. While a variety of carriers have been developed for holding shingles in position on a side of a roof to be available for use by the roofer, they all extend on one side of the roof. Typically, the roof ridge, however, is shingled by a worker bending or kneeling to one side of the ridge and utilizing a nailing gun to place individual shingles in overlapped, sealed relationship. Sometimes the roofer will sit and straddle the ridge during such installation. Such working positions are, at best, inefficient and uncomfortable.

Thus, there exists a need for a system by which a roofer can expeditiously move along a roof, and particularly the roof ridge, for installing the final covering of shingles on the roof ridge.

### SUMMARY OF THE INVENTION

The ridge roofing cart of the present invention satisfies this need by providing an elongated platform on which a roofer can sit and which includes four wheels mounted to pairs of axles to position wheels on opposite sides of the roof ridge. The angles of the axles can be adjusted, such that opposed wheels remain in a plane generally orthogonal to the slanted roof sides while the platform is longitudinally centered along the ridge and can easily be rolled along the roof. The platform has space for holding shingles as well as providing a seating area for the roofer. The axles are mounted to the center platform by a bracket which allows the angle of the axles to be adjusted to correspond to different pitched roofs so that the cart can easily travel along the ridge of a roof and maintain a safe and convenient operating position for the roofer.

The present invention comprises mounting brackets for receiving an elongated support platform. Each bracket includes spaced plates for receiving an axle between the plates on each side thereof and an aperture for receiving an axle pivot pin at one position on the bracket. Each bracket has a plurality of apertures spaced from the pivot aperture for setting the angular position of the axle on each side of the bracket in relationship to the support platform corresponding to standard roof pitch angles. The brackets can be mounted at opposite ends of a support platform to define a cart in which the axles rotatably hold wheels which span the ridge of a roof. Such an arrangement allows the support platform to be centered over the roof ridge and maintains the cart in alignment with the roof ridge as the roofer applies roof ridge shingles and moves along the roof of a building utilizing the cart. Such a cart, therefore, greatly improves the efficiency of applying roof ridge shingles as well as a safe and effective manner for the workmen to install shingles along the roof ridge.

These and other features, objects and advantages of the present invention will become apparent upon reading the following description thereof together with reference to the accompanying drawings.

### BRIEF DESCRIPTION OF THE DRAWINGS

FIG. 1 is a perspective view of a building roof showing a roofer utilizing the roofing cart of the present invention;

FIG. 2 is a perspective view of the ridge roofing cart of the present invention;

FIG. 3 is an exploded perspective view of one of the mounting brackets and pair of axles and wheels associated therewith; and

FIG. 4 is an end elevational view, partly in phantom, showing the adjustable features of the axle angles corresponding to different roof pitches.

### DETAILED DESCRIPTION OF THE PREFERRED EMBODIMENT

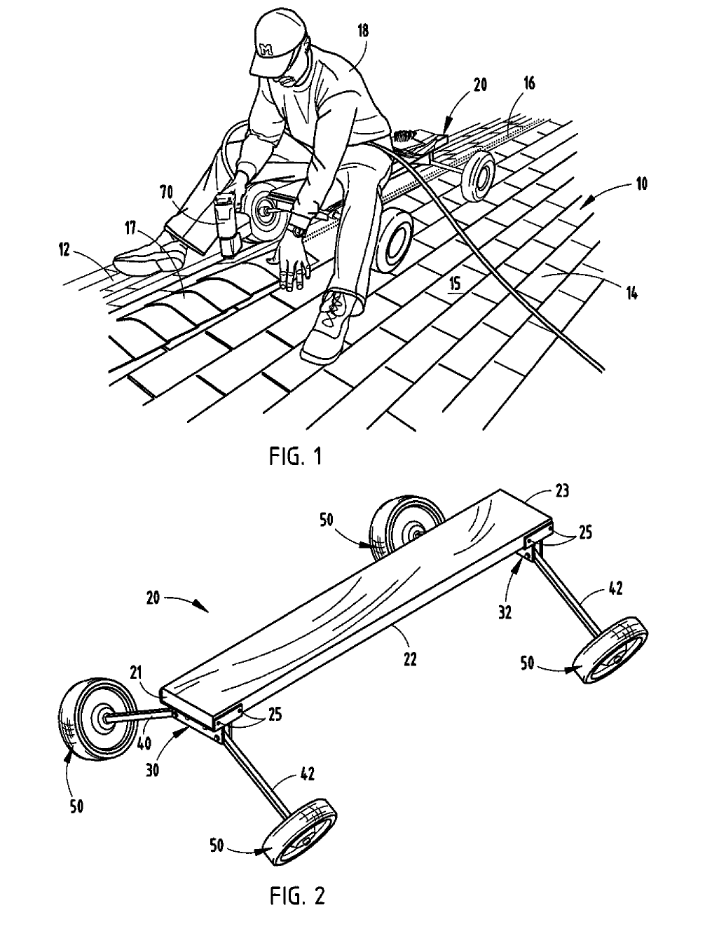

FIG. 1 shows a typical building 10 which has a pair of slanted roof sections 12 and 14 which converge along a peak or ridge 16. Roof sections 12 and 14 are shingled in a conventional manner with overlapping shingles 15 typically placed on the roof starting at the lower edge or eaves and overlapping until they abut adjacent the ridge 16 from sides 12 and 14. The ridge 16 is subsequently shingled with overlapping shingles 17 by the roofer 18 utilizing, in the preferred embodiment of this invention, the ridge roofing cart 20 of the present invention.

Cart 20, as best seen in FIG. 2, has an elongated center platform 22 which can be a precut dimensioned lumber, such as a 2×8 piece of lumber, which is anywhere from three to four feet in length, although it can be any desired length or formed of a molded polymeric material, fiberglass, or other weatherproof material of sufficient strength. Typically, cart 20 will employ a wooden central platform made of pressure-treated wood.

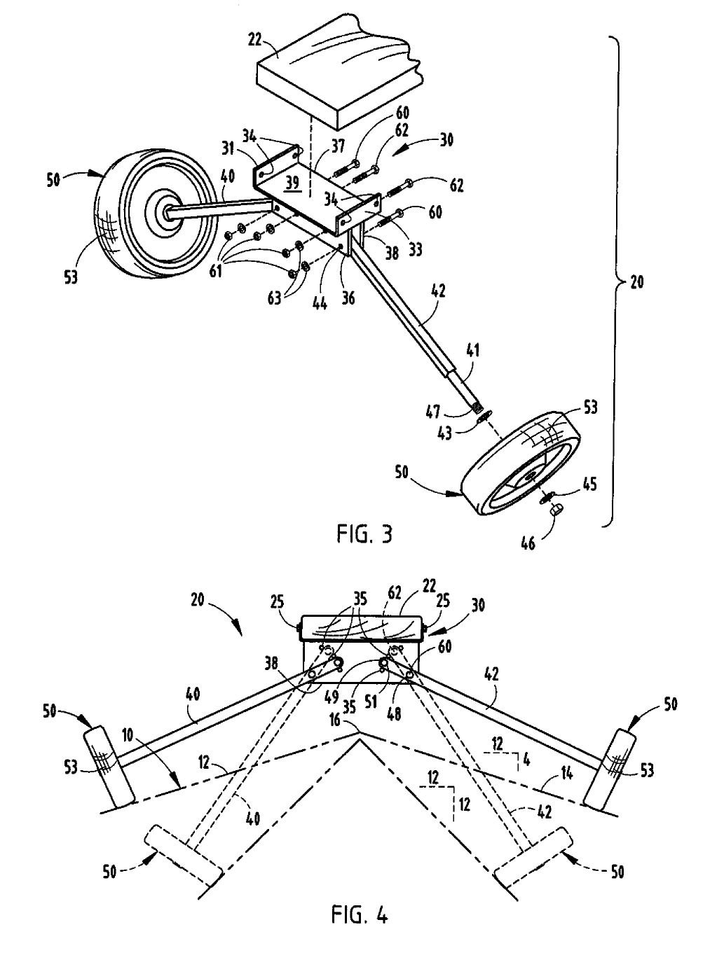

At opposite ends 21 and 23 of platform 22 are mounting brackets 30 and 32 which are substantially of the same configuration, such that only bracket 30 is described in detail. Bracket 30, as shown in FIG. 3, is fabricated from steel which is protected from the environment, such as by galvanizing, painting, powder coating or the like, to withstand use in an outdoor environment over time. The bracket 30 comprises a U-shaped upper section 37 with a floor 39 (FIG. 3) and upwardly extending end walls 31 and 33 horizontally spaced-apart a distance to closely receive the center support 22 therebetween. Each of the walls 31 and 33 include apertures 34 for receiving fasteners, such as screws 25 (FIGS. 2 and 4), which attach the sides of ends 21 and 23 of the center support or platform 22 to the brackets. Bracket 30 also includes downwardly depending, spaced-apart parallel plates 36 and 38 orthogonal to U-shaped upper section 37 between which extend axles 40 and 42 of the cart 20. The axles can be of any desired cross-sectional configuration, although each of the ones shown in the figures has a generally square cross section with a rounded end 41 for receiving a wheel 50 in rotatable engagement therewith. Wheel 50 is mounted to the end 41 (FIG. 3) of each of the axles by means of a washer 43 on one side, a second washer 45 on the opposite side, and a self-locking nut 46 which is mounted to a threaded end 47 of axle end 41.

Axles 40 and 42 each include a first aperture 48 in spaced relationship to end 49 (FIG. 4) opposite the wheel 50 and a second aperture 51 near end 49 to allow the axles 40 and 42 to be adjustably mounted between the plates 36 and 38 of bracket 30. For such purpose, the plates 36 and 38 each include an arcuate arrangement of a plurality of apertures 35 (typically five) arranged in an arc about aperture 48 in axles 40 and 42 to allow the axles to be mounted between the plates in selectable angular relationship to the center platform 22 corresponding to the pitch of a roof on which the cart will be used. For such purpose, a pivot axle, such as a bolt 60, extends through aperture 48 in axles 40 and 42 and through corresponding apertures 44 (FIG. 3) in plates 36 and 38 and is held in place by a lock washer 63 and nut 61. A second locking bolt 62 extends through a selected one of the apertures 35 in plates 36, 38 and through aperture 51 in the end of axles 40, 42 to position the axles 40, 42 in fixed relationship (FIGS. 3 and 4) in angular relationship to the platform 22 corresponding to the roof pitch. Lock washers 63 and nuts 62 secure the end 49 of axles 40, 42 to brackets 30, 32. One of the positions, shown in solid lines in FIG. 4, shows the mounting relationship of axles 40 and 42 with respect to the brackets 30 and 32 for a 12/4 roof pitch, which is a relatively shallow pitch, between the intersecting roof sections 12 and 14 and which positions the cart 20 directly over the ridge 16 of the building. In another selected position, the axles 40, 42 are moved to align with a 12/12 pitch roof, as shown in phantom lines in FIG. 4.

By arranging the arcuately aligned apertures 35 and spaced plates 36 and 38 a distance apart corresponding to the various standard pitch roof angles, the wheels 50 of cart 20 can be positioned to ride on roof sections 12 and 14 in a manner to stably position the ridge roofing cart 20 over the center or ridge of the roof, allowing the roofer 18 to place shingles, such as shingles 19, on the end of the cart in front of the roofer and utilize a nail gun 70 for installing the ridge shingles 17 easily from the cart by placing the with its end in a position near and directly above the work space while maintaining the cart in a stable aligned relationship to the roof of building 10. To apply successive shingles, the roofer easily pushes the cart rearwardly with his/her legs toward the edge of the roof. Naturally, as the roofer approaches the end of the roof, the position is reversed and the final ridge shingles are installed onto the ridge from the opposite end of the cart.

Brackets 30 and 32 can be fabricated by welding steel together or can be molded of a structural polymeric material, such as nylon reinforced polyethylene, fiberglass, or other weather-resistant material, which provides sufficient rigidity and strength for holding the weight of the shingles, the roofer, and the platform 22, as well as receiving the axles 40 and 42 at each end of the cart 20. The axles 40, 42 in a preferred embodiment are solid steel, typically about ½″×½″ and have a length of about 16 inches to about 20 inches to provide a sufficiently stable base between wheels 50 for both supporting the roofer as well as a stable platform from which to operate while moving along the ridge of the roof. The axles are also treated to be weather-resistant. The wheels 50 typically will include a friction engaging outer thread 53 providing traction against the shingles and an internal integral bearing (not shown) and are standard commercially available wheels. The typical overall diameter for such wheels is 6 inches, and they preferably have pneumatic tires with treads for engaging the roof surfaces.

With the ridge roofing cart of the present invention, the task of applying roof ridge shingles is safely facilitated and the cart provides a means for holding shingles to be applied to the roof ridge as well as movably supporting the roofer as the cart and roofer move along the roof ridge for the installation of such shingles. Although the invention is described in the environment of shingling the ridge of a roof, other coverings, such as continuous strips, could also be mounted to platform 22 to unroll and cover the roof ridge. Also, the cart could be used on roofs having different pitched sides by adjusting the axles on one side differently than the other. The cart formed by the axles and brackets may have applications in other environments as well. It will become apparent to those skilled in the art that these and other modifications to the preferred embodiment of the invention as described herein can be made without departing from the spirit or scope of the invention as defined by the appended claims.

The invention claimed is:

1. A system for constructing a cart for applying a covering to the ridge of a roof comprising:
a pair of support brackets for receiving opposite ends of a platform, said brackets including spaced-apart mounting plates for receiving axles extending at selectable angles from said brackets;
axles extending outwardly from opposite sides of each of said brackets; and
wheels rotatably mounted at ends of said axles, whereby said axles can be adjusted with respect to said bracket to correspond to the pitch of a roof.

2. The system as defined in claim 1 wherein said brackets each included an upper generally U-shaped section with a floor and spaced-apart walls for receiving an elongated platform between said walls.

3. The system as defined in claim 2 wherein said mounting plates extend downwardly from said floor in generally orthogonal relationship to said walls.

4. The system as defined in claim 2 wherein said plates include a plurality of apertures with a first one of said apertures defining a pivot location for said axles and an arcuate array of second apertures defining adjustment locations for said axles.

5. The system as defined in claim 4 wherein said axles include a first aperture near an end opposite said wheel and a second aperture spaced from said first aperture such that said second aperture in said axle aligns with said first aperture in said plates and said first aperture in said axle aligns with a selected one of said arcuate second apertures in said plate.

6. The system as defined in claim 5 wherein said axles are selectively fixed in angular relationship to said floor by a pivot pin extending through said first aperture in said plates and said second aperture in said axles and a bolt extending through one of said second apertures in said plate and said first aperture in said axle.

7. The system as defined in claim 6 wherein said axles are rectangular in cross section.

8. The system as defined in claim 6 wherein said axles are square in cross section.

9. A cart for applying shingles to the ridge of a roof comprising:
an elongated support platform for supporting shingles at least at one end and a worker behind the shingles;
a pair of support brackets for mounting near opposite ends of said platform for receiving said support platform, said brackets each including spaced-apart mounting plates for adjustably receiving axles;
axles extending outwardly from opposite sides of each of said brackets; and
wheels rotatably mounted to the ends of said axles and the angular position of said axles can be adjusted to correspond to the pitch of a roof such that the cart aligns with the roof and stably positions the cart in movable relationship along the roof ridge.

10. A cart as defined in claim 9 wherein said brackets each include an upper generally U-shaped section with a floor and spaced-apart walls for receiving said platform between said walls.

11. A cart as defined in claim 10 wherein said mounting plates extend downwardly from said floor in generally orthogonal relationship to said walls.

12. A cart as defined in claim 11 wherein said plates include a plurality of apertures with a first one of said apertures defining a pivot location for said axles and an arcuate array of second apertures defining adjustment locations for said axles.

13. A cart as defined in claim 12 wherein said axles include a first aperture near an end opposite said wheel and a second aperture spaced from said first aperture such that said second aperture in said axle aligns with said first aperture in said plates and said first aperture in said axle aligns with a selected one of said arcuate second apertures in said plate.

14. A cart as defined in claim 13 wherein said axles are selectively fixed in angular relationship to said floor by a pivot member extending through said first aperture in said plates and said second aperture in said axles and a bolt extending through one of said second apertures in said plate and said first aperture in said axle.

15. A cart as defined in claim 14 wherein said axles are rectangular in cross section.

16. A cart as defined in claim 15 wherein said axles are square in cross section.

17. A cart for finishing the ridge of a roof comprising:
an elongated wooden support platform;
a pair of steel support brackets, each having a generally U-shaped upper section for receiving an end of said platform, said brackets including spaced-apart downwardly extending mounting plates for adjustably receiving axles;
axles extending outwardly from opposite sides of each of said brackets and having one end mounted in adjustable relationship to said bracket; and
a wheel rotatably mounted at an opposite end of each axle such that the cart can be placed on a roof and the angular position of said axles adjusted to correspond to the pitch of the roof such that the cart aligns with the roof and stably positions the cart in movable relationship along the roof ridge.

18. A cart as defined in claim 17 wherein said axles are pivotally mounted between said mounting plates.

19. A cart as defined in claim 18 wherein said mounting plate includes an arcuate array of apertures and said axles include an aperture which can be selectively aligned with one aperture of said array of apertures and locked in place with a bolt to fix the selected angular position of said axles.

20. A cart as defined in claim 19 wherein said wheels include pneumatic tires.
